(19) United States
(12) Patent Application Publication
(10) Pub. No.: US 2026/0212508 A1
(43) Pub. Date: Jul. 23, 2026

(54) GENERATING BLURRED BACKGROUNDS AND RESIZING IMAGE OBJECTS FROM A SEGMENTATION MASK

(71) Applicant: Capital One Services, LLC, McLean, VA (US)

(72) Inventors: Deepak RAMAMOHAN, Mysuru (IN); B Videep Kumar REDDY, Bangalore (IN)

(73) Assignee: Capital One Services, LLC, McLean, VA (US)

(21) Appl. No.: 19/028,743

(22) Filed: Jan. 17, 2025

(51) Int. Cl. G06T 7/11; G06T 7/194

(52) U.S. Cl. CPC G06T 7/11; G06T 7/194; G06T 2207/20224; G06T 2207/30248

(57) ABSTRACT

Disclosed herein are system, method, and computer program product embodiments for generating a segmentation mask of an image object; determining a sizing of the segmentation mask, wherein the sizing includes a bounding box around the image object; based on determining the sizing to be outside a threshold sizing ratio, resizing the segmentation mask to be equal to or within the threshold sizing ratio; determining, based on a center point of the image object, that the resized image object is not centered; centering the resized segmentation mask resizing, centering the digital imagery such that the image object is of a same size and occupies a same position as the resized and centered segmentation mask; and rendering, from the resized and centered digital imagery, a final image. A final image may also include background blurring, padding and whitening.

### BACKGROUND

A number of techniques currently exist to enable identifying foreground image objects in imagery. However, lagging behind are improvements to systems where when viewing images on the Internet or in a web-browser, a user can view extracted image objects that appear consistent across differing image objects.

### BRIEF DESCRIPTION OF THE DRAWINGS/FIGURES

FIG. 1 depicts an illustration for extracting image objects, according to some embodiments.

FIG. 2 depicts an illustration for generating a segmentation mask, according to some embodiments.

FIG. 3 depicts a flow diagram for implementing a segmentation mask process for an image object, according to some embodiments.

FIG. 4 depicts an illustration of a flow diagram for generating a centered and resized image object and mask with a blurred background, according to some embodiments.

FIG. 5 depicts another illustration of a flow diagram for generating a centered and resized image object, according to some embodiments.

FIGS. 6A and 6B depicts a graphical illustration for resizing for an image object and mask, according to some embodiments.

FIG. 7 depicts an illustration of a flow diagram for generating a blurred background, according to some embodiments.

FIG. 8 depicts an illustration of a flow diagram for generating image objects from a segmentation mask with a blurred background, according to some embodiments.

FIG. 9 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

Provided herein are system, apparatus, device, method and/or computer program product embodiments, and/or combinations and sub-combinations thereof, for extracting, sizing and centering foreground imagery for an image object from imagery. A segmentation mask may include contiguous pixels of the image object to be processed. The segmentation mask is essentially an array that identifies each pixel as either belonging to the foreground, i.e., vehicle in an example embodiment, or the background. However, the segmentation mask may also include unwanted sizing, lack centering, or include distracting background detail. For example, objects may be incorrectly sized or centered relative to a frame rendering. In various embodiments, technical improvements are disclosed to improve the segmentation mask by resizing and centering of a segmentation mask when applying the mask to an image. In some embodiments, backgrounds may be blurred surrounding the applied mask.

Many car buyers will shop for vehicles online in order to browse the cars without traveling to a location of the vehicle. Consistent imagery with realistic image objects may enhance or improve the browsing experience. In various embodiments, an imaging process may generate a segmentation mask of an image object (e.g., one obtained after passing an image through a segmentation algorithm), remove stray segments from the mask, smooth the edges of the segmentation mask and apply the updated mask to identify background imagery while preserving the foreground image object (e.g., a vehicle). The current implementation provides technical improvements to the process for purposes of generating consistent viewable image objects, by resizing, centering, and implementing background blurring using any of the embodiments disclosed herein.

Various embodiments of these features will now be discussed with respect to the corresponding figures.

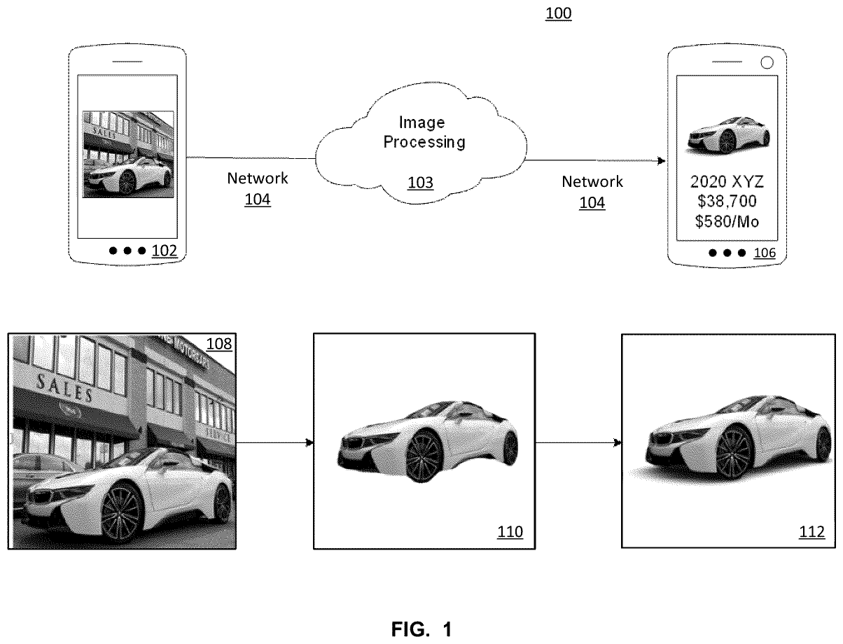

FIG. 1 depicts an illustration of a system 100 for extracting foreground imagery of an image object, according to some embodiments. System 100 will be described throughout for an example vehicle image object. However, the system and processes described herein may be applied to any imagery to separate a foreground image object from background imagery.

System 100 may include a vehicle owner (e.g., private or dealership) interacting with a camera device 102 (e.g., a smartphone) to generate on-site vehicle imagery 108. The vehicle imagery 108 may be communicated to a local, remote, or a distributed computing system, such as image processing system 103, to execute image processing steps with an imaging application to separate a foreground vehicle image object from background imagery.

Image processing system 103 may include one or more server devices (e.g., a host server, a web server, an application server, etc.), a data center device, or a similar device, capable of communicating with camera device 102 via network 104. The server may include an image processor, authenticator, image recognizer, object classifier, model generator, and object database. In some embodiments, the server may be implemented as a plurality of servers that function collectively as a cloud database for storing/processing imagery and data received from camera device 102. The plurality of servers can be co-located at a single location (e.g., server farm) or be geographically distributed across multiple locations and/or multiple servers. In some embodiments, the server may be used to store the vehicle imagery 108, an extracted image object 110, an image with shadows 112, a segmentation mask, or vehicle information.

Collectively, an object processor and authenticator may perform security functions described above for an image application including processing the object information, processing requests associated with accessing, uploading, and deleting files, just to name a few examples. Instead of processing image information locally in camera device 102, it may send the image information to the server to perform the processing remotely. An authenticator may be used to authenticate user or location information and encrypt/decrypt data based on information provided by camera device 102. The object database stores objects and associated information. Like object storage, the object database may, in some aspects, differ from conventional storage in that it is configured specifically to store unstructured data associated with objects as a single element. User device 106 may be connected to the image processing system 103 or to a dealer's system (e.g., server platform) through wired or wireless communication networks 104 to receive and render (e.g., display) a chosen object (e.g., vehicle or vehicles) on a computing device display. User device 106 may include a device, such as a mobile phone (e.g., a smart phone, a radiotelephone, etc.), a laptop computer, a personal computer, a tablet computer, a handheld computer, a gaming device, a wearable communication device (e.g., a smart wristwatch, a pair of smart eyeglasses, augmented reality headsets, interactive heads-up display (HUD), etc.), or a similar type of device. In some embodiments, user device 106 may include a location sensor for location based searching of available vehicles for purchase. Examples of location sensors include any combination of a global position system (GPS) sensor, a digital compass, a IR distance measurement element, cameras with associated camera position solving software, velocitimeter (velocity meter), an accelerometer, or any known or future location systems.

While described as separate from image processing system 103, a dealer's system may be implemented as one or more servers located in the cloud, another cloud processing system, or by a local or remote dealership server network. Dealer System may include one or more servers or databases, such as an inventory database, storing existing vehicle inventory as identified, for example, by a vehicle ID. A vehicle information database may store specific vehicle information (pricing, features, options, color, specifications (e.g., drivetrain information, horsepower, torque, length, width, height, etc.) associated with a vehicle ID in the existing inventory. An image database may ingest vehicle imagery 108 from the inventory from various sources such as mobile devices with cameras, fixed cameras, etc. Also, the dealer may ingest imagery of same or different vehicles from the internet, social media, or third-party apps.

In some embodiments, when interacting with a physical object, the image application may require multiple images and/or a panoramic view of the physical object. Multiple images from different camera views and angles may be required so that subsequent access is not limited to only one camera angle. These multiple images could then be stored as part of the image object information.

In some embodiments, the image application may also include image processing capabilities to remove certain information or features from an image of the object (e.g., taken from the real-time view) to prevent the chances of false segmentation mask elements (e.g., stray pixels or holes in the vehicle profile) or improper identifications in a vehicle search. For example, if stray segments are included as part of the captured object information, accessing the storage location associated with that vehicle at a later time could require the same stray segments to appear in order to provide subsequent identification. To avoid that situation, the image application may remove the background from the vehicle imagery 108, remove the stray segments, and store that processed image of the image object 110 as object information (e.g., segmentation mask) in a storage location. In this manner, recognizing the vehicle would not be dependent on the specific circumstances of the object when the object was originally created.

In some embodiments, camera device 102 may include hardware components for displaying a real-time view of the physical surroundings in which camera device 102 is used. The camera device 102 may also support one or more image resolutions. In some embodiments, an image resolution may be represented as a number of pixel columns (width) and a number of pixel rows (height), such as 1280×720, 1920×1080, 2592×1458, 3840×2160, 4128×2322, 5248×2952, 5322×2988, or the like, where higher numbers of pixel columns and higher numbers of pixel rows are associated with higher image resolutions.

In some embodiments, camera device 102 may be implemented using one or more camera lenses with each lens having different focal lengths or different capabilities. For example, there may be a wide-angle lens (e.g., 28-35 mm), a telephoto (zoom) lens (e.g., 55 mm and above), a lens with a depth sensor, a lens with a monochrome sensor, or a “standard” lens (e.g., 35-55 mm). Determining a depth of field may be calculated using a dedicated lens having a depth sensor (e.g., Light Detection and Ranging (LIDAR)) or using multiple camera lenses (e.g., telephoto lens in combination with a standard lens).

In some embodiments, the determined distance or depth between camera device 102 and the object may be used to determine a relative location of the object. The relative location of the object refers to the spatial relationship between the object and surrounding objects or the frame of the image. The relative location may be used in combination with the physical location to identify the object.

In some embodiments, camera device 102 may also be used to detect the contour of objects displayed in the real-time view. Contour information for each object may be stored as object information. Some object information may be available and/or more accurate when camera device 102 is implemented using more than one camera lens. For example, camera device 102 may be implemented with three camera lenses could be more accurate in acquiring depth of field information and determining the exact relative position and contour between different objects. A contour may generally be considered to be three-dimensional information associated with the object.

In one example, the image application may take advantage of the different capabilities of each lens in performing its object detection and analysis. For example, one lens may be configured to recognize lighting in the real-time view and can distinguish between day and night clearly; an ultra-wide-angle lens can support wide-angle picture shooting and capture additional details regarding objects surrounding the selected object; yet another lens may be a telephoto lens which supports optical zoom to capture specific details regarding the selected object. The image application may then utilize the information provided by each lens of camera device 102 for not only identifying objects within real-time view, but also securely storing and accessing data. In this manner, the image application may be tailored to the capabilities of camera device 102 while still providing the complete functionality as described in this disclosure.

In some embodiments, object information (e.g., contour, size, color, shape) may also be used when verifying that a selected object matches the object that is associated with a location. For example, when the vehicle information is created, an image object 110 of the physical object may be stored as part of the creation process. When subsequent access to the vehicle location is requested, the image application may determine that the subsequent access is associated with the same physical object that was used to create the vehicle data. In some embodiments, this may be done via an image comparison between an image of the object that was previously stored and an image of the object that is provided with the request.

In some embodiments, the camera device 102 may support a first image resolution that is associated with a quick capture mode, such as a low image resolution for capturing and displaying low-detail preview images on a display of the user device. In some embodiments, the camera device 102 may support a second image resolution that is associated with a full capture mode, such as a high image resolution for capturing a high-detail image. In some embodiments, the full capture mode may be associated with the highest image resolution supported by the camera device 102.

Network 104 may include one or more wired and/or wireless networks. For example, the network 104 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

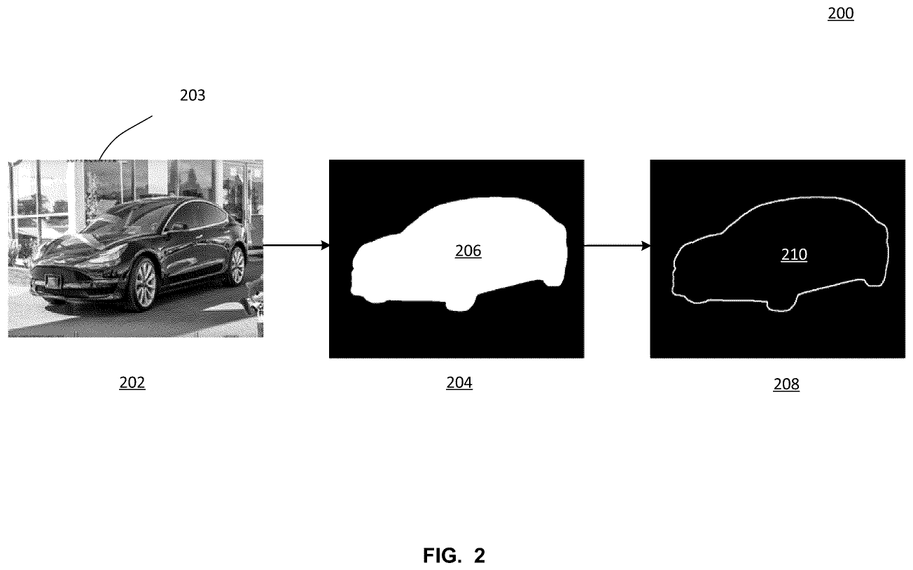

FIG. 2 depicts a high-level illustration 200 for extracting image objects from imagery, according to some embodiments. As a non-limiting example with regard to FIG. 1, one or more processes described with respect to FIGS. 2-9 may be performed by an image processing system (e.g., image processing system 103 of FIG. 1), an image processing application on any of the devices 102 or 106, or a server for processing imagery associated with a physical object that is displayable on a computing device (e.g., mobile device 106).

In one processing stage 202, segmentation mask 206 may be generated by partitioning a digital image 203 (e.g., vehicle image 108) into multiple image segments, also known as image regions or image objects (e.g., sets of pixels). The result of image segmentation is a set of segments that collectively cover the entire image object.

In one processing stage 204, the foreground image object (e.g., vehicle) pixels may subsequently be separated from the background pixels using the segmentation mask 206 and identifying boundaries (lines, curves, contours, etc.) of the image object.

In one processing stage 208, the image application generates a contour 210 from the segmentation mask 206. In one embodiment, a set of contours (e.g., edges) may be extracted from the image by defining an array of points along the ‘boundary’ of the mask, which generally follow a closed curve.

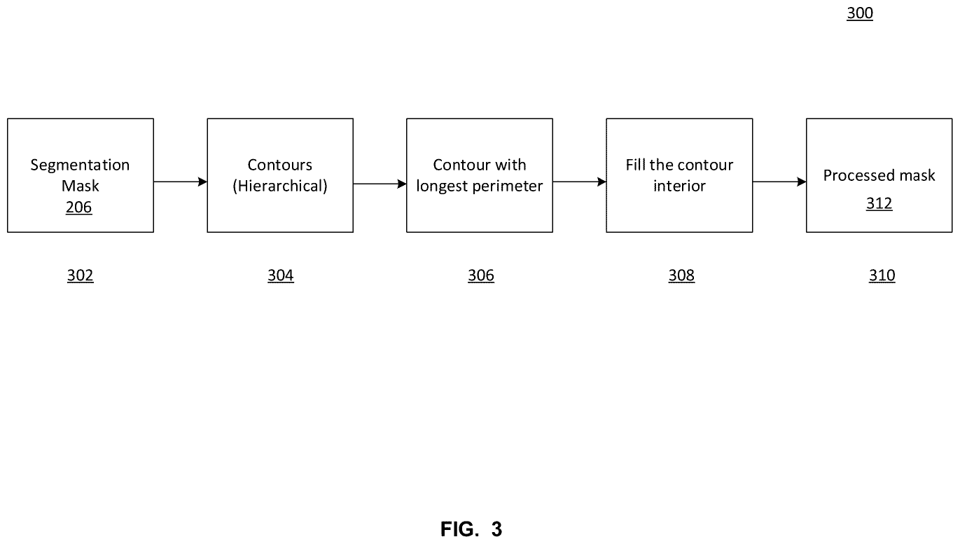

FIG. 3 depicts a flow diagram 300 for implementing a segmentation mask process for an image object, according to some embodiments. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

In one processing stage 302, the image application may generate a segmentation mask 206 by partitioning the vehicle imagery 108 into multiple image segments, also known as image regions or image objects (e.g., sets of pixels). Segmentation mask 206, includes the contiguous pixels of the object, but also may include unwanted pixels along the contours of the object or areas where holes in the mask may exist. For example, the segmentation mask may include at least an array of contiguous pixels of the image object within the digital imagery as well as additional pixels (e.g., strays) located outside a perimeter boundary of the image object's segmentation mask.

In one processing stage 304, a set of contours (e.g., edges) may be extracted from the segmentation mask by defining an array of points along the ‘boundary’ of the mask, which generally follows at least a partially closed curve. Each of the pixels in a region are similar with respect to some characteristic or computed property, such as color, intensity, or texture, to name a few. However, contour segments formed from the stray pixels may be included in a first version of the segmentation mask. In some aspects, an analysis of contours, by size, is implemented to identify relative sizes of detected contours (or closed curves) of the segmentation mask 206. The analysis may generate a hierarchical listing of contours by size (e.g., perimeter lengths).

In one processing stage 306, a contour with a longest perimeter is selected form the hierarchical listing, which may be chosen to identify the region of contiguous pixels of the segmentation mask of the image object, but, by only selecting the longest contour, may eliminate shorter stray segments.

In one processing stage 308, an interior region of the largest contour is filled with a common pixel value. For example, white or black regions may identify the image object by masking the entire area of the image object.

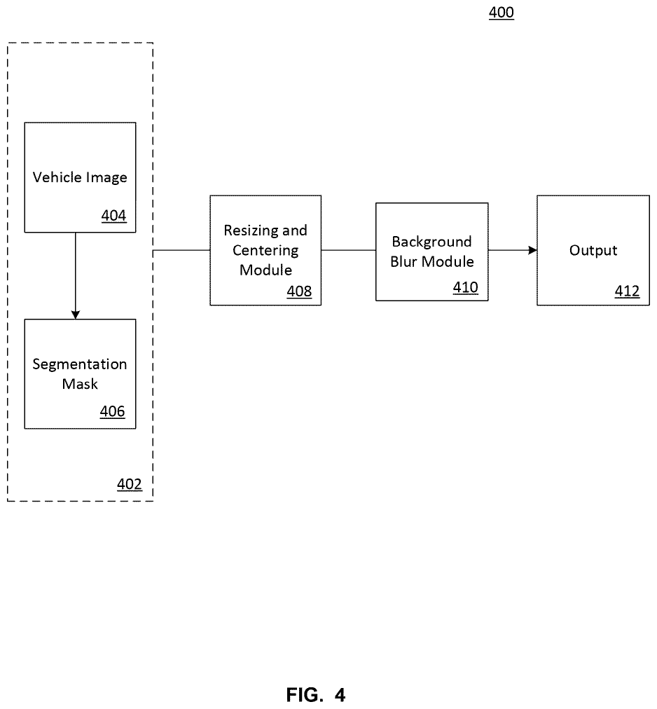

In one processing stage 310, once filled, the processed segmentation mask 312 (e.g., second version of the segmentation mask) may be used to resize, center or blur the background, as described in various embodiments herein, or be further processed to improve the contour(s) of the segmentation mask as further described in FIG. 4.

FIG. 4 depicts an illustration of a flow diagram 400 for generating of a centered and resized image object with a blurred background, according to some embodiments. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

In various embodiments, a segmentation mask 402 generator implements an algorithm that takes as an input a vehicle image 404 and separates a foreground object from background imagery to generate a segmentation mask 406 using any of the embodiments described herein. The foreground object includes an image of an object, such as a vehicle.

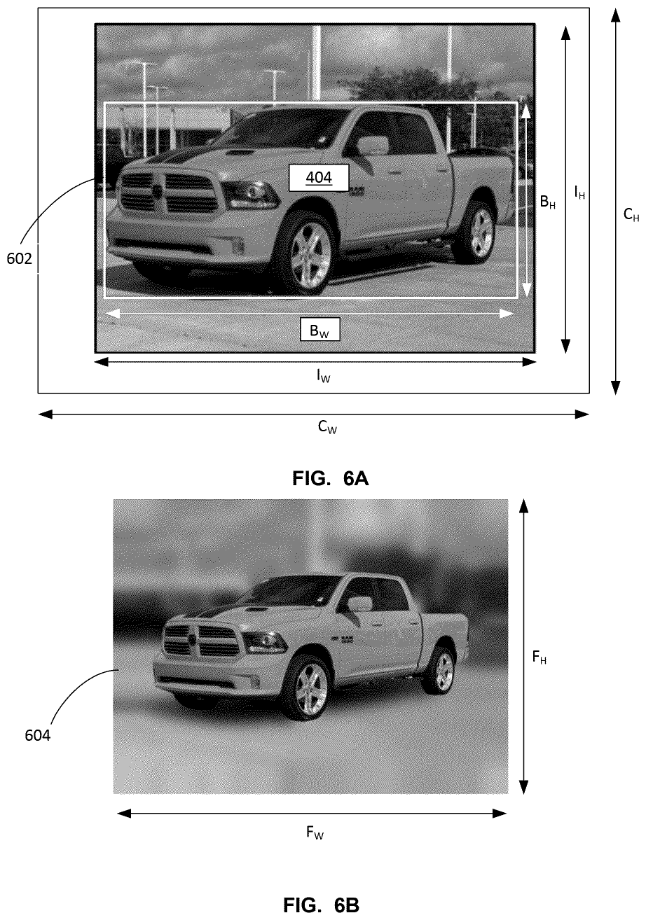

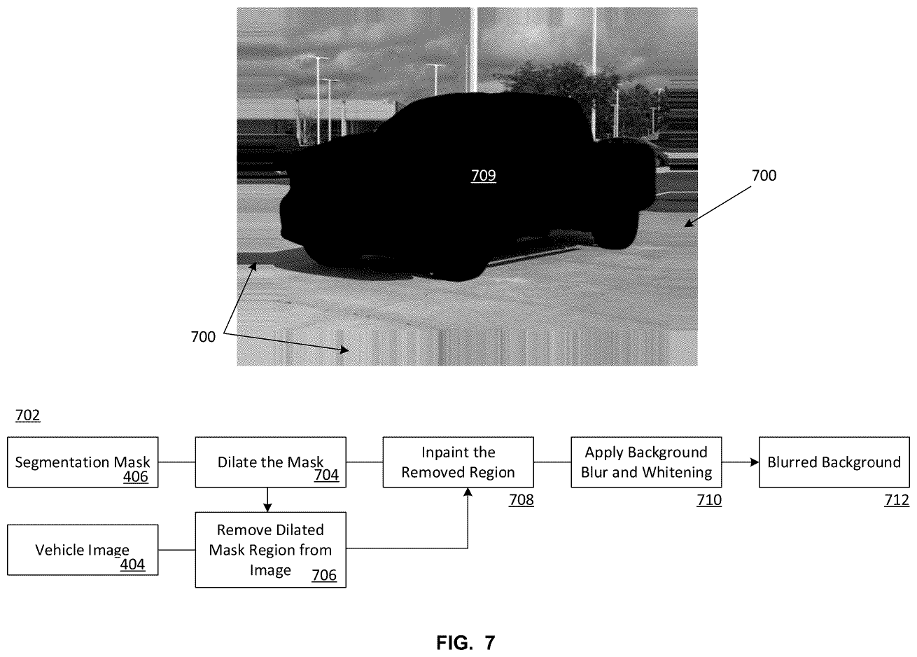

Resizing and Centering Module 408, crops, resizes, and centers the vehicle image such that the vehicle may occupy a predefined size, e.g., not exceeding 80% of width or 60% of height (whichever is greater). In various embodiments, the ratios may be different for the height and width. As will be discussed in greater detail in association with FIGS. 6A-8, resizing and centering module 408 takes two inputs, an image and a mask, and outputs an image where a region corresponding to the mask may occupy a predefined size, e.g., up to 80% of width and up to 60% height, in the output. In addition, a center of the region may be determined by a rectangular bounding box that tightly encloses the region defined by the segmentation mask 406. Alternatively, the center may be calculated by (1) calculating a weighted average of the perimeter or a bounding ellipse around the segmentation mask 406, or (2) calculating a weighted average of a volume of regions of the segmentation mask 406. This centering point may be labeled as the corresponding center of the segmentation mask 406 and a center to a corresponding rectangular bounding box (FIG. 6, element 602) as the center of the image. In some aspects, ‘missing’ regions from the image following these operations may be optionally ‘padded’ using boundary conditions or left black. For example, after centering an image, image pixels may be missing along a perimeter of the re-centered image. In one aspect, as further described in FIG. 7, replicated edge pixels may be added to one or more image borders of varying thicknesses based on a number of replicated pixels. Alternatively, or in addition to, black or white pixels (e.g., on one side or as a frame) may be added to fill these missing pixel areas.

In some embodiments, a background blur module 410 may add blur and ‘whitening’ to the background, while ensuring that there is no “color bleed” around the vehicle in an output image 412. In this context, “color bleeding” refers to the “halo”-like effect produced around an object after the background is blurred. In a non-limiting example, there may be a red “halo” around a red vehicle, with the color “bleeding” onto background objects.

By combining these two modules (resizing and centering module 408 and background blur module 410), the algorithm generates vehicle images with specified background blur and whitening levels. These images are free from the “color bleed” effect and are standardized. Optionally, shadows can be generated for the vehicle in an image and ‘sandwiched’ between the background and the vehicle object (e.g., see image with shadows 112). While described as combined, any of the resizing, centering or background blurring functions may be implemented individually or in various combinations without departing from the scope of the technology disclosed herein.

The technology disclosed herein provides a plurality of technical improvements to mask based object extractions, resulting in a standardization of vehicle images, especially when they're displayed in a grid, such in a search results page. In addition, blurred background images may assist customers to focus on the vehicles they're searching for, without getting distracted by the background.

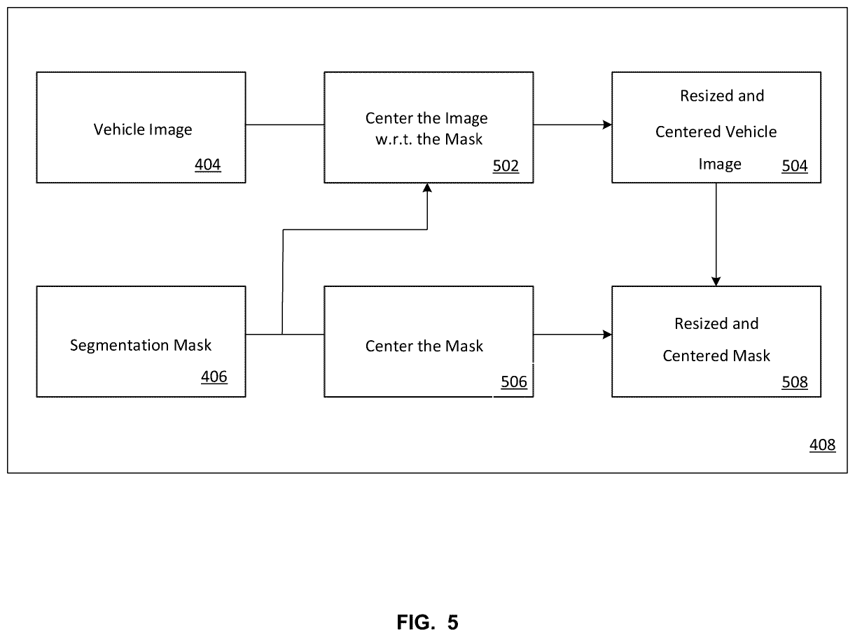

FIG. 5 depicts another illustration of a flow diagram for generating a centered and resized image object as per resizing and centering module 408, according to some embodiments. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

As previously described, a segmentation mask generator 402 implements an algorithm that takes as an input a vehicle image 404 and separates a foreground object from background imagery to generate a segmentation mask 406 using any of the embodiments described herein. The foreground object includes an image of an object, such as a vehicle. As will be discussed in greater detail hereafter, a final output image, in some embodiments, selects two inputs, an image and a mask, and outputs an image where a region corresponding to the mask occupies a predefined size defined by width and height ratio limits. By combining outputs from image processing path (404, 502, and 504) and mask processing path (406, 506, and 508), the algorithm generates resized and centered vehicle images. In embodiments, the separately centered and resized image and mask components may be recombined at a later time, for example, for insertion into various backgrounds or to be used when blurring existing backgrounds.

In some embodiments, the image processing path may include centering module 502. Centering module 502, centers the vehicle image with respect to (w.r.t.) a center point of the segmentation mask 406, such that the vehicle occupies a predefined region. The center of the region may be determined by the center of a rectangular bounding box that tightly encloses the region defined by the segmentation mask 406. Alternatively, the center may be calculated by (1) calculating a weighted average of the perimeter or a bounding ellipse around the segmentation mask 406, or (2) calculating a weighted average of a volume of regions of the segmentation mask 406. This centering point may be labeled as the corresponding center of the segmentation mask 406 and a center to a corresponding rectangular bounding box as the center of the image. The centered image will be resized such that a region corresponding to the mask may occupy a predefined size, e.g., up to 80% width or 60% height, in the resized and centered output vehicle image 412.

In some embodiments, the mask processing path may include mask centering module 506 to center the segmentation mask 406. In some embodiments, mask centering module 506 may be the same as centering module 502, with the mask itself being used as an input instead of the vehicle image. Mask centering module 506, centers the mask around a center point, such that the segmentation mask of the vehicle occupies a predefined region. The output of this module is a resized and centered mask 508, which is “aligned” with the resized and centered vehicle image 504 generated by the centering module 502. In other words, the resized and centered mask 508 substantially matches the size, shape and location of the vehicle object in the resized and centered vehicle image 504.

FIG. 6A and FIG. 6B, collectively, depict a graphical illustration for image resizing for image and mask objects, according to some embodiments.

In various embodiments, an algorithm resizes an image such that the vehicle occupies a selected size in the final image 604 shown in FIG. 6B. The final image 604 may be a different resolution and aspect ratio compared to the original image, e.g., the final image 604 may be 1280×720 whereas the original image is 640×480. The algorithm is independent of the choice of the final image resolution. The size of the vehicle object is defined using two independent ratio parameters, r_{w} and rₕ (e.g., 80% and 60%), for the maximum width and height of the vehicle object in the final image respectively. In various embodiments, the ratios may be different for the height and width. The resizing may be performed in such a way that the aspect ratio and shape of the vehicle object are preserved, i.e., the object is not ‘stretched’ horizontally/vertically or skewed otherwise. Due to this constraint, in most circumstances, only one of the two ratios may hold true for the object in the final resized and centered image—either (1) the width of the object is exactly r_{w} times the image width and the height is less than rₕ times the height, or (2) the width of the object is less than r_{w} times the image width and the height exactly equal to rₕ times the height. The ratio parameters can be independently and dynamically increased or decreased based on a presentation mode, e.g., landscape vs. portrait or based on arrangement, e.g., an array of images.

In one embodiment, the algorithm to determine a ratio of a resized image may follow, but is not limited to:
B_{w}=width of the tight bounding box; Bₕ=height of the tight bounding box
   I_{w}=width of the input image; Iₕ=height of the input image
   F_{w}=width of the final image, Fₕ=height of the final image
      C_{w}=width of crop region; Cₕ=height of crop region

$${B}_{w} / {B}_{h} = {A}_{box} \qquad ( 1 )$$

$${F}_{w} / {F}_{h} = {C}_{w} / {C}_{h} = A \qquad ( 2 )$$

One of the following two constraints must be satisfied:

$${B}_{w} / {C}_{w} = {r}_{w} and {B}_{h} / {C}_{h} \leq {r}_{h} \qquad ( 3 )$$

$$OR$$

$${B}_{w} / {C}_{w} \leq {r}_{w} and {B}_{h} / {C}_{h} = {r}_{h} \qquad ( 4 )$$

where r_{w} and rₕ are predefined, e.g., 0.8 (80%) and 0.6 (60%) respectively

If we assume the first constraint (equation (3)) to be true, then

$${B}_{w} / {C}_{w} = {r}_{w} ⇒ {C}_{w} = {B}_{w} / {r}_{w}$$

$${B}_{h} / {C}_{h} \leq {r}_{h} ⇒ {C}_{h} \geq {B}_{h} / {r}_{h}$$

From equation (1), C_{w}/Cₕ=A⇒Cₕ=C_{w}/A

$$∴ {C}_{h} \geq {B}_{h} / {r}_{h} ⇒ {C}_{w} / A \geq {B}_{h} / {r}_{h} ⇒ {C}_{w} \geq {B}_{h} * A / {r}_{h} ⇒ {B}_{w} / {r}_{w} \geq {B}_{h} * A / {r}_{h}$$

⇒B_{w}/Bₕ≥A*(r_{w}/rₕ)

If we assume the second constraint (equation (4)) to be true, then

$${B}_{h} / {C}_{h} = {r}_{h} ⇒ {C}_{h} = {B}_{h} / {r}_{h}$$

$${B}_{w} / {C}_{w} \leq {r}_{w} ⇒ {C}_{w} \geq {B}_{w} / {r}_{w}$$

From equation (1), C_{w}/Cₕ=A⇒C_{w}=Cₕ*A

$$∴ {C}_{w} \geq {B}_{w} / {r}_{w} ⇒ {C}_{h} * A \geq {B}_{w} / {r}_{w} ⇒ ( {B}_{h} / {r}_{h} ) * A \geq {B}_{w} / {r}_{w} ⇒ {B}_{w} / {B}_{h} \leq A * ( {r}_{w} / {r}_{h} )$$

FIG. 7 depicts a graphical illustration for image generating a padded and blurred background for an image object, according to some embodiments. In some aspects, ‘missing’ regions from the image following these centering and resizing operations may be optionally ‘padded’ using boundary conditions or left black. For example, after centering an image, image pixels may be missing along a perimeter of the re-centered image. In one aspect, replicated edge pixels 700 may be added to one or more image borders of varying thicknesses based on a number of replicated pixels. Alternatively, or in addition to, black or white pixels (e.g., on one side or as a frame) may be added to fill these missing pixel areas.

In various embodiments, an algorithm for calculating padding may follow, but is not limited to:

Algorithm

```
If B_{w}/Bₕ ≥ A * (r_{w}/rₕ):
  C_{w} = B_{w}/r_{w}
  Cₕ = C_{w}/A
Else:
  Cₕ = Bₕ/rₕ
  C_{w} = Cₕ * A
$( {X}_{center}^{C} , {Y}_{center}^{C} ) = ( {X}_{center}^{B} , {Y}_{center}^{B} )$
$( {X}_{min}^{C} , {Y}_{min}^{C} ) = ( {X}_{center}^{B} - ⌊ {C}_{w} / 2 ⌋ , {Y}_{center}^{B} - ⌊ {C}_{h} / 2 ⌋ )$
$( {X}_{max}^{C} , {Y}_{max}^{C} ) = ( {X}_{center}^{B} + ⌊ {C}_{w} / 2 ⌋ , {Y}_{center}^{B} - ⌊ {C}_{h} / 2 ⌋ )$
${pad}_{left} = max ( 0 , {X}_{min}^{C} )$
${pad}_{right} = max ( 0 , {X}_{max}^{C} - {I}_{w} + 1 )$
${pad}_{top} = max ( 0 , - {Y}_{min}^{C} )$
${pad}_{bottom} = max ( 0 , {Y}_{max}^{C} - {I}_{h} + 1 )$
image_{C} = add_padding(image_{I}, pad_{left}, pad_{right}, padₜₒₚ, pad_{bottom})
scale_factor = F_{w}/C_{w}
image_{F} = resize_image(image_{C}, scale_factor)
```

In some embodiments, the resizing operation to obtain a final image F from the intermediate ‘crop region’ image C may be performed using image interpolation or super resolution techniques. In some embodiments, the resizing module may be applied twice with different paddings (boundary and zero) for the image and mask respectively.

As shown in blur processing flow 702, segmentation mask 406 is dilated (e.g., enlarged) in 704. In 706, the dilated mask region may be removed from vehicle image 404. In 708, the removed dilated mask region is in-painted, for example, as shown 709 in the top graphic illustration. In-painting is a process that involves restoring or repairing an image by filling in missing, damaged, or deteriorated parts. In 710, the background may be blurred, whitened (e.g., brightened) or both, resulting in a final image with blurred background 712.

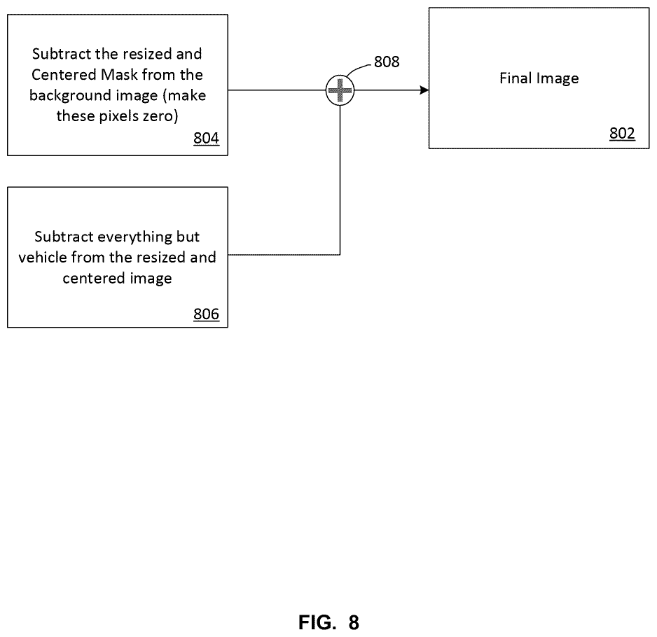

FIG. 8 depicts a graphical illustration for image resizing for an image object, according to some embodiments. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 8, as will be understood by a person of ordinary skill in the art.

Final image 802 (e.g., FIG. 6B, element 604) is generated, in 804, by subtracting a resized and centered mask from a background of vehicle image 404 to generate a first intermediate image. In one embodiment, a pixel value of zero may be assigned to these pixels to implement the subtracting. In 806, the remaining pixels (e.g., everything except the vehicle pixels) are subtracted from the vehicle image 404 to generate a second intermediate image. The outputs from 804 and 806 (the first intermediate image and second intermediate image) are recombined in 808, resulting in a final image 802 that may include any or all of centering, resizing, padding, blurring, or whitening according to the embodiments described herein.

The technology described herein improves the extraction and presentation of image objects from background objects and generates a realistic image object (e.g., expected) that may be added to one or more selected backgrounds. One technical solution disclosed includes the centering of image objects during mask generation. One technical solution disclosed herein recognizes sizing or scaling of the image object and generates a resized image object. One technical solution disclosed herein includes improvement of the image output by padding centered imagery. One technical solution disclosed herein includes improvement of the image output by blurring and/or whitening a background of the imagery. While described for a vehicle, the disclosed technology may be applied to any imagery.

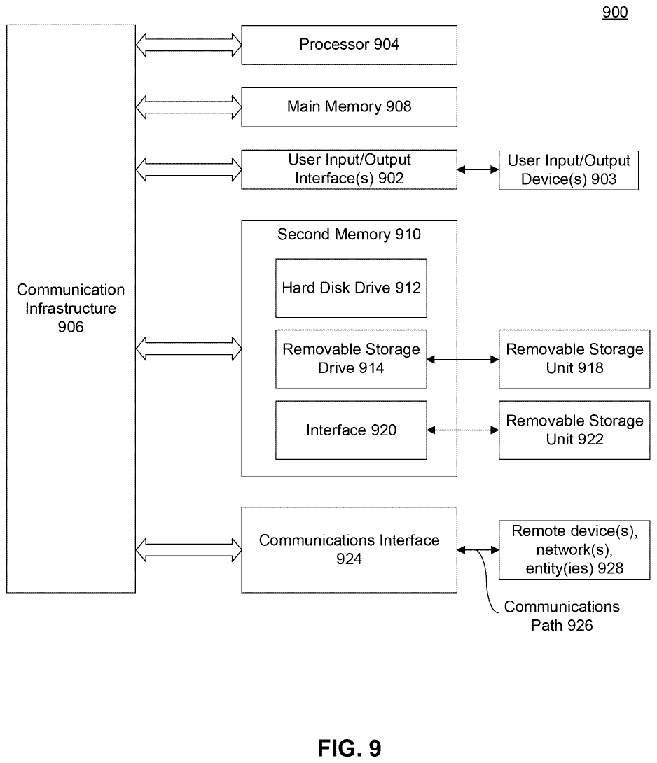

Various embodiments may be implemented, for example, using one or more well-known computer systems, such as computer system 900 shown in FIG. 9. One or more computer systems 900 may be used, for example, to implement any of the embodiments discussed herein, as well as combinations and sub-combinations thereof. Computer system 900 may include one or more processors (also called central processing units, or CPUs), such as a processor 904. Processor 904 may be connected to a communication infrastructure or bus 906.

Computer system 900 may also include user input/output device(s) 904, such as monitors, keyboards, pointing devices, etc., which may communicate with communication infrastructure 906 through user input/output interface(s) 902.

One or more of processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method to process digital imagery, the computer-implemented method comprising:
generating a segmentation mask of an image object, wherein the segmentation mask comprises at least an array of first pixels of the image object within a digital image and second pixels located outside a perimeter boundary of the segmentation mask;
determining a sizing of the segmentation mask, wherein the sizing includes a bounding box around the image object;
based on determining the sizing to be outside a threshold sizing ratio, resizing the segmentation mask to be equal to or within the threshold sizing ratio;
determining, based on a center point of the segmentation mask, that the segmentation mask is not centered;
centering the segmentation mask;
resizing and centering the digital image such that the image object is of a same size and occupies a same position as the resized and centered segmentation mask; and
rendering, based on the resized and centered segmentation mask and the resized and centered digital image, a final image.

2. The computer-implemented method of claim 1, wherein the rendering comprises:
subtracting the resized and centered segmentation mask from the second pixels to generate a first intermediate image;
subtracting the second pixels from the resized and centered digital image to generate a second intermediate image; and
adding the first intermediate image to the second intermediate image.

3. The computer-implemented method of claim 1, wherein the center point of the object is determined by averaging a weighted perimeter of the segmentation mask.

4. The computer-implemented method of claim 1, wherein the center point of the object is determined by averaging a weighted volume of regions of the segmentation mask.

5. The computer-implemented method of claim 1, wherein the center point of the object is determined by averaging a perimeter of a bounding ellipse around the segmentation mask.

6. The computer-implemented method of claim 1, wherein the threshold sizing ratio comprises two independent ratio parameters, r_{w} and rₕ, for a maximum width and height of the vehicle object in the final image.

7. The computer-implemented method of claim 1, further comprising blurring the second pixels located outside a perimeter boundary of the resized and centered segmentation mask.

8. The computer-implemented method of claim 7, further comprising replicating one or more pixels along an outer edge of the blurred second pixels to pad the blurred second pixels.

9. The computer-implemented method of claim 1, wherein the image object is a vehicle.

10. A system, comprising:
a memory; and
one or more processors configured to:
generate a segmentation mask of an image object, wherein the segmentation mask comprises at least an array of first pixels of the image object within the digital imagery and second pixels located outside a perimeter boundary of the segmentation mask;
determine a sizing of the segmentation mask, wherein the sizing includes a bounding box around the image object;
based on determining the sizing to be outside a threshold sizing ratio, resize the segmentation mask to be equal to or within the threshold sizing ratio;
determine, based on a center point of the segmentation mask, that the segmentation mask is not centered;
center the segmentation mask;
resize and centering the digital image such that the image object is of a same size and occupies a same position as the resized and centered segmentation mask; and
render, based on the resized and centered segmentation mask and the resized and centered digital image, a final image.

11. The system of claim 10, further configured to:
subtract the resized and centered segmentation mask from the second pixels to generate a first intermediate image;
subtract the second pixels from the resized and centered digital image to generate a second intermediate image; and
add the first intermediate image to the second intermediate image to render the final image.

12. The system of claim 10, further configured to determine the center point by averaging a weighted perimeter of the segmentation mask.

13. The system of claim 10, further configured to determine the center point by averaging a weighted volume of regions of the segmentation mask.

14. The system of claim 10, further configured to determine the center point by averaging a perimeter of a bounding ellipse around the segmentation mask.

15. The system of claim 10, wherein the threshold sizing ratio comprises two independent ratio parameters, r_{w} and rₕ, for a maximum width and height of the vehicle object in the final image.

16. The system of claim 10, further configured to blur the second pixels located outside a perimeter boundary of the resized and centered segmentation mask.

17. The system of claim 16, further configured to replicate one or more pixels along an outer edge of the blurred second pixels to pad the blurred second pixels.

18. The system of claim 11, wherein the image object is a vehicle.

19. A non-transitory computer-readable device having instructions stored thereon that, when executed by at least one computing device, causes the at least one computing device to perform operations comprising:
generating a segmentation mask of an image object, wherein the segmentation mask comprises at least an array of first pixels of the image object within the digital imagery and second pixels located outside a perimeter boundary of the segmentation mask;
determining a sizing of the segmentation mask, wherein the sizing includes a bounding box around the image object;
based on determining the sizing to be outside a threshold sizing ratio, resizing the segmentation mask to be equal to or within the threshold sizing ratio;
determining, based on a center point of the segmentation mask, that the segmentation mask is not centered;
centering the segmentation mask;
resizing and centering the digital image such that the image object is of a same size and occupies a same position as the resized and centered segmentation mask; and
rendering, based on the resized and centered segmentation mask and the resized and centered digital image, a final image.

20. The non-transitory computer-readable device of claim 19, wherein the rendering further comprises operations:
subtracting the resized and centered segmentation mask from the second pixels to generate a first intermediate image;
subtracting the second pixels from the resized and centered digital image to generate a second intermediate image; and
adding the first intermediate image to the second intermediate image.
